(19) United States
(12) Patent Application Publication
(10) Pub. No.: US 2026/0054175 A1
(43) Pub. Date: Feb. 26, 2026

(54) INFORMATION DISPLAY METHOD AND APPARATUS FOR VIRTUAL OBJECT, DEVICE, AND MEDIUM

(71) Applicant: TENCENT TECHNOLOGY (SHENZHEN) COMPANY LIMITED, Shenzhen (CN)

(72) Inventor: Ying DENG, Shenzhen (CN)

(21) Appl. No.: 19/374,761

(22) Filed: Oct. 30, 2025

Related U.S. Application Data
(63) Continuation of application No. PCT/CN2024/137678, filed on Dec. 9, 2024.

(30) Foreign Application Priority Data
Jan. 11, 2024 (CN) 202410047677.4

(51) Int. Cl. A63F 13/5372; A63F 13/52; A63F 13/56; A63F 13/822; A63F 13/837

(52) U.S. Cl. CPC A63F 13/5372; A63F 13/52; A63F 13/56; A63F 13/822; A63F 13/837

(57) ABSTRACT

An information display method for a virtual object includes: displaying a virtual scene image, the virtual scene image being an image of a virtual scene captured from a perspective of a first virtual object; displaying a threat warning control in the virtual scene image, the threat warning control indicating a position of the second virtual object within a threat warning range, the second virtual object and the first virtual object belonging to different game camps, and the threat warning range being greater than a visible range of the first virtual object and less than a perception range of the first virtual object; and displaying a threat object model in the virtual scene image in response to a trigger operation on the threat warning control, the threat object model representing attribute information of the second virtual object.

### CROSS-REFERENCES TO RELATED APPLICATIONS

The present disclosure is a continuation of PCT Application No. PCT/CN2024/137678, filed on Dec. 9, 2024, which claims priority to Chinese Patent Application No. 2024100476774, filed with the China National Intellectual Property Administration on Jan. 11, 2024 and entitled “INFORMATION DISPLAY METHOD AND APPARATUS FOR VIRTUAL OBJECT, DEVICE, MEDIUM, AND PROGRAM PRODUCT”, the entire contents of all of which are incorporated herein by reference.

### FIELD OF THE TECHNOLOGY

Embodiments of the present disclosure relate to the field of human-computer interaction technologies, and in particular, to information display of a virtual object.

### BACKGROUND OF THE DISCLOSURE

With the development of computer technologies and improvement of device performance, human-computer interaction interfaces of electronic games gradually attract attention. In a massive multiplayer online role-playing game (MMORPG), a user may manipulate a virtual object to perform activities in a virtual scene image.

When facing a threatening virtual object, the user first needs to search for the virtual object within a visible range by switching perspectives, and then learns information about the virtual object through observation and attack probe in a case of finding the virtual object.

The above-described information obtaining process of a virtual object is complex, and information obtaining efficiency is relatively low.

### SUMMARY

Embodiments of the present disclosure provide an information display method and apparatus for a virtual object, a terminal, and a storage medium, to simplify an information obtaining process and improve efficiency of obtaining virtual object information. The technical solutions are as follows.

According to an aspect, an embodiment of the present disclosure provides an information display method for a virtual object, the method including: displaying a virtual scene image, the virtual scene image being an image of a virtual scene captured from a perspective of a first virtual object; displaying a threat warning control in the virtual scene image after a second virtual object enters a threat warning range of the first virtual object, the threat warning control indicating a position of the second virtual object within the threat warning range, the second virtual object and the first virtual object belonging to different game camps, and the threat warning range being greater than a visible range of the first virtual object and less than a perception range of the first virtual object; and displaying a threat object model in the virtual scene image in response to a trigger operation on the threat warning control, the threat object model representing attribute information of the second virtual object.

According to another aspect, an embodiment of the present disclosure provides an information display method for a virtual object, the apparatus including: an image display module, configured to display a virtual scene image, the virtual scene image being an image of a virtual scene captured from a perspective of a first virtual object; a control display module, configured to display a threat warning control in the virtual scene image after a second virtual object enters a threat warning range of the first virtual object, the threat warning control indicating a position of the second virtual object within the threat warning range, the second virtual object and the first virtual object belonging to different game camps, and the threat warning range being greater than a visible range of the first virtual object and less than a perception range of the first virtual object; and a model display module, configured to display a threat object model in the virtual scene image in response to a trigger operation on the threat warning control, the threat object model representing attribute information of the second virtual object.

According to another aspect, an embodiment of the present disclosure provides a computer device, the computer device including a processor and a memory, the memory having a computer program stored therein, and the computer program being loaded and executed by the processor, to implement the information display method for a virtual object in the foregoing aspect.

According to another aspect, an embodiment of the present disclosure provides a computer-readable storage medium, the storage medium having a computer program stored therein, and the computer program being executed by a processor, to implement the information display method for a virtual object in the foregoing aspect.

In the embodiments of the present disclosure, in response to that the second virtual object enters the threat warning range, the terminal indicates the position of the second virtual object within the threat warning range by displaying the threat warning control. Further, in response to that the threat warning control is triggered, the terminal displays the threat object model that represents the attribute information of the second virtual object, and the user obtains attribute information of the second virtual object within a field of view with no need to manipulate the first virtual object to approach the second virtual object, thereby simplifying an obtaining process of virtual object information, and improving information obtaining efficiency. In addition, the user can make a strategic decision in advance based on display information, thereby effectively avoiding risks, and improving engagement efficiency of the first virtual object in a case of preparing for engagement.

### BRIEF DESCRIPTION OF THE DRAWINGS

FIG. 1 is a schematic diagram of an implementation environment according to an exemplary embodiment of the present disclosure;

FIG. 2 is a flowchart of an information display method for a virtual object according to an exemplary embodiment of the present disclosure;

FIG. 3 is a schematic diagram of a virtual scene image of a moving process of a first virtual object according to an exemplary embodiment of the present disclosure;

FIG. 4 is a schematic diagram of a virtual scene image of a plurality of threat warning controls according to an exemplary embodiment of the present disclosure;

FIG. 5 is a schematic diagram of implementation of a display process of a threat object model according to an exemplary embodiment of the present disclosure;

FIG. 6 is a flowchart of an information display method for a virtual object according to another exemplary embodiment of the present disclosure;

FIG. 7 is a schematic diagram of color filling of a threat object model according to an exemplary embodiment of the present disclosure;

FIG. 8 is a schematic diagram of a threat degree of a threat object model according to an exemplary embodiment of the present disclosure;

FIG. 9 is a schematic diagram of a target display position of a threat object model in response to that a second virtual object is located within a scene range according to an exemplary embodiment of the present disclosure;

FIG. 10 is a schematic diagram of a target display position of a threat object model in response to that a second virtual object is located outside a scene range according to an exemplary embodiment of the present disclosure;

FIG. 11 is a schematic diagram of a virtual scene image including an arrow identifier in response to that a second virtual object is located outside a scene range according to an exemplary embodiment of the present disclosure;

FIG. 12 is a schematic diagram of an edge position of a threat warning control according to an exemplary embodiment of the present disclosure;

FIG. 13 is a schematic diagram of a virtual scene image in response to that a second virtual object enters a threat warning range again according to an exemplary embodiment of the present disclosure;

FIG. 14 is a schematic diagram of implementation of a perspective locking process according to an exemplary embodiment of the present disclosure;

FIG. 15 is a schematic diagram of implementation of a transparency process of a threat object model according to an exemplary embodiment of the present disclosure;

FIG. 16 is a flowchart of an information display process of a virtual object according to an exemplary embodiment of the present disclosure;

FIG. 17 is a block diagram of a structure of an information display apparatus for a virtual object according to an exemplary embodiment of the present disclosure; and

FIG. 18 is a block diagram of a structure of a terminal according to an exemplary embodiment of the present disclosure.

### DESCRIPTION OF EMBODIMENTS

To make the objectives, technical solutions, and advantages of the present disclosure clearer, the following further describes implementations of the present disclosure in detail with reference to the accompanying drawings.

The term “plurality of” mentioned herein refers to two or more. “And/or” describes an association relationship between associated objects and indicates that three relationships may exist. For example, A and/or B may indicate the following cases: Only A exists, both A and B exist, and only B exists. The character “/” generally indicates an “or” relationship between the associated objects.

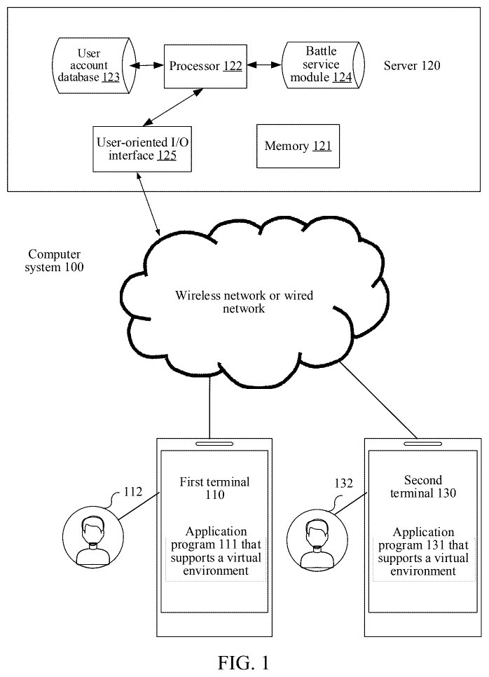

FIG. 1 is a schematic diagram of an implementation environment according to an exemplary embodiment of the present disclosure. The implementation environment may include a first terminal 110, a server 120, and a second terminal 130.

An application program 111 that supports a virtual environment is run in the first terminal 110, where the application program 111 may be a multiplayer online battle program. When the first terminal runs the application program 111, a user interface of the application program 111 is displayed on a screen of the first terminal 110. The application program 111 may be any one of a multiplayer online battle arena (MOBA) game, a simulation game (SLG), a massive multiplayer online role-playing game (MMORPG), and a first-person shooting (FPS) game. In this embodiment, an example in which the application program 111 is a massive multiplayer online role-playing game is used for description. The first terminal 110 is a terminal used by a first user 112. The first user 112 uses the first terminal 110 to control a first virtual object in a virtual environment to perform activities. The first virtual object may be referred to as a main controlled virtual object of the first user 112. The activities of the first virtual object include but are not limited to at least one of the following: adjusting a body posture, crawling, walking, running, riding, flying, jumping, driving, picking, shooting, attacking, throwing, and releasing skills. For example, the first virtual object is a first virtual character such as a simulated character or a cartoon character.

An application program 131 that supports a virtual environment is run in the second terminal 130, and the application program 131 may be the multiplayer online battle program. When the second terminal 130 runs the application program 131, a user interface of the application program 131 is displayed on a screen of the second terminal 130. A client may be any one of an MOBA game, an SLG, an MMORPG, and an FPS game. In this embodiment, an example in which the application program 131 is an MMORPG is used for description. The second terminal 130 is a terminal used by a second user 132. The second user 132 uses the second terminal 130 to control a second virtual object in a virtual environment to perform activities, and the second virtual object may be referred to as a main controlled virtual character of the second user 132. For example, the second virtual object is a second virtual character, such as a simulated character or a cartoon character.

In some embodiments, the first virtual object and the second virtual object are in the same virtual world. In some embodiments, the first virtual object and the second virtual object may belong to the same camp, the same team, and the same organization, and have a friend relationship or have a temporary communication permission. In some embodiments, the first virtual object and the second virtual object may belong to different game camps, different teams, and different organizations, or have an adversarial relationship.

In some embodiments, application programs installed on the first terminal 110 and the second terminal 130 are the same, or application programs installed on the two terminals are application programs of the same type on different operating system platforms (that is, Android or IOS). The first terminal 110 may generally refer to one of a plurality of terminals, and the second terminal 130 may generally refer to another one of the plurality of terminals. In this embodiment, only the first terminal 110 and the second terminal 130 are used as examples for description. Device types of the first terminal 110 and the second terminal 130 are the same or different, and the device types include at least one of the following: a smartphone, a tablet computer, an e-book reader, a moving picture experts group audio layer III (MP3) player, a moving picture experts group audio layer IV (MP4) player, a laptop portable computer, and a desktop computer.

FIG. 1 shows only two terminals. However, there are a plurality of other terminals that can access the server 120 in different embodiments. In some embodiments, one or more terminals are terminals corresponding to a developer. By installing a developing and editing platform for an application program that supports a virtual environment in the terminal, the developer can edit and update the application program on the terminal, and transmit an updated application program installation package to the server 120 through a wired or wireless network. The first terminal 110 and the second terminal 130 may download the application program installation package from the server 120 to update the corresponding application program.

The first terminal 110, the second terminal 130, and another terminal are connected to the server 120 through a wired network or wireless network.

The server 120 includes at least one of one server, a server cluster including a plurality of servers, a cloud computing platform, and a virtualization center. The server 120 is configured to provide a backend service for an application program that supports a three-dimensional virtual environment. In some embodiments, the server 120 is in charge of primary computing works, and the terminal is in charge of secondary computing works; alternatively, the server 120 is in charge of the secondary computing works, and the terminal is in charge of the primary computing works; and alternatively, the server 120 and the terminal perform collaborative computing by using a distributed computing architecture.

For example, the server 120 includes a memory 121, a processor 122, a user account database 123, a battle service module 124, and a user-oriented input/output interface (I/O interface) 125. The processor 122 is configured to load instructions stored in the server 120, and process data in the user account database 123 and the battle service module 124. The user account database 123 is configured to store data of user accounts used by the first terminal 110, the second terminal 130, and the another terminal, such as avatars of the user accounts, nicknames of the user accounts, fighting power indexes of the user accounts, and service areas of the user accounts. The battle service module 124 is configured to provide a plurality of battle rooms for users to battle, for example, a 1V1 battle, a 3V3 battle, a 5V5 battle, and a 1V5 battle. The user-oriented I/O interface 125 is configured to establish communication between the first terminal 110 and/or the second terminal 130 via a wireless network or a wired network for data exchange.

With reference to the above introduction, the information display method for a virtual object provided in the present disclosure is described. In this embodiment of the present disclosure, an example in which the method is performed by a terminal device is used for description.

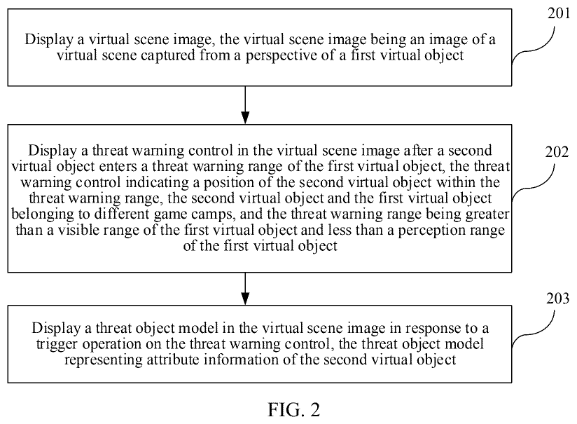

FIG. 2 is a flowchart of an information display method for a virtual object according to an exemplary embodiment of the present disclosure. This embodiment may be executed by a terminal device, and the terminal device may be described by using an example in which the method is applied to the first terminal 110 or the second terminal 130 in an implementation environment shown in FIG. 1 or another terminal in the implementation environment. The method includes the following operations.

Operation 201: Display a virtual scene image, the virtual scene image being an image of a virtual scene captured from a perspective of a first virtual object.

The virtual object is a movable object in a virtual environment that can be controlled by a user. The movable object may be a virtual chess piece, a virtual character, a virtual animal, a cartoon character, or the like, such as a person, an animal, a plant, an oil drum, a wall, or a stone displayed in the virtual environment. In some embodiments, the virtual object is a three-dimensional model created based on a skeletal animation technology. Each virtual object has a shape and size in the virtual environment, and occupies some space in the virtual environment.

The virtual scene refers to a virtual environment in which the virtual object locates in a virtual world during running of an application program. The virtual scene image refers to an image presented to a user when the virtual object performs activities in a virtual scene. The virtual scene image may include another virtual object that is in the same virtual scene as the virtual object.

In some embodiments, the perspective of the first virtual object may be a first-person perspective of the first virtual object, or may be a third-person perspective of the first virtual object. In this embodiment of the present disclosure, the third-person perspective is used as an example. The virtual scene is photographed by using a camera model corresponding to the first virtual object, to obtain a virtual scene image from the third-person perspective of the first virtual object.

The camera model refers to a three-dimensional model around a virtual object in a virtual world (may not be displayed in a virtual scene). When the first-person perspective is used, the camera model is located near the head of the virtual object or on the head of the virtual object; and when the third-person perspective is used, the camera model may be located behind the virtual object and be bound to the virtual object, or may be located at any position at a preset distance of the virtual object. By using the camera model, the virtual object in the virtual world may be observed from different perspectives. In some embodiments, when the third-person perspective is a first-person over-the-shoulder perspective, the camera model is located behind the virtual object (such as the head and the shoulder of the virtual object). In some embodiments, in addition to the first-person perspective and the third-person perspective, the perspective further includes other perspectives, such as a top-down perspective. When the top-down perspective is used, the camera model may be located above the head of the virtual object, and the top-down perspective is a perspective for overlooking the virtual world from the air. In some embodiments, the camera model is not actually displayed in the virtual world. In other words, the camera model is not displayed in the virtual world that is displayed in a user interface.

In some embodiments, the camera model automatically follows a virtual character in the virtual world. To be specific, when a position of a virtual object in the virtual world changes, a position of the camera model changes simultaneously along with the position of the virtual object in the virtual world, and the camera model is always within a preset distance range of the virtual object in the virtual world. In some embodiments, in an automatic following process, relative positions between the camera model and the virtual object remain unchanged.

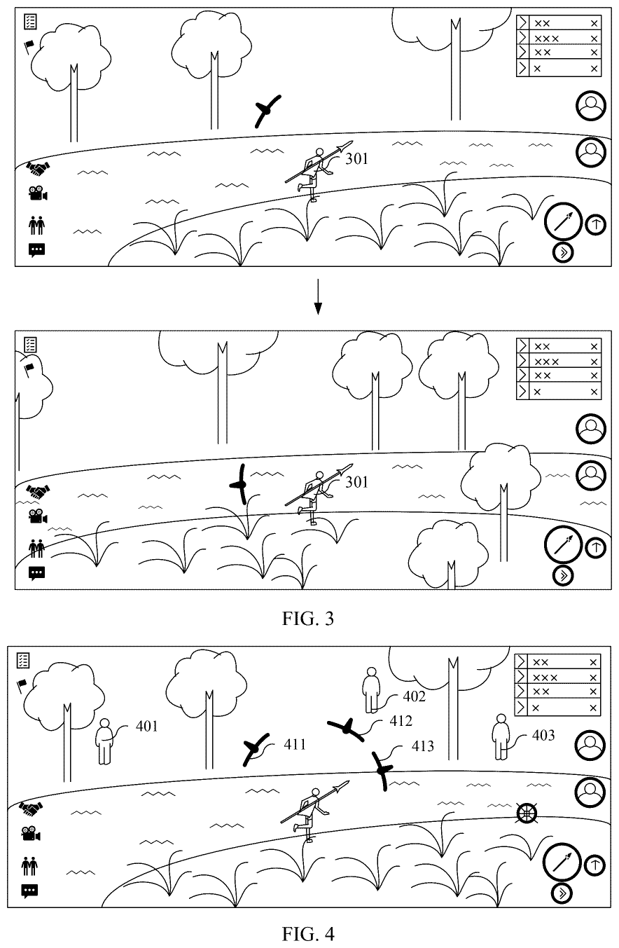

For example, as shown in FIG. 3, the virtual scene image is centered on the first virtual object 301, and a lens of the camera model automatically moves with the first virtual object 301.

Operation 202: Display a threat warning control in the virtual scene image after a second virtual object enters a threat warning range of the first virtual object, the threat warning control indicating a position of the second virtual object within the threat warning range, the second virtual object and the first virtual object belonging to different game camps, and the threat warning range being greater than a visible range of the first virtual object and less than a perception range of the first virtual object.

In some embodiments, there may be a plurality of second virtual objects within the perception range of the first virtual object, or there may be only one second virtual object.

In response to that there are a plurality of second virtual objects in the perception range of the first virtual object, the terminal uses a plurality of threat warning controls to indicate relative directions of different second virtual objects, and in response to a trigger operation on the threat warning control, displays a threat object model of the second virtual object indicated by the threat warning control.

For example, as shown in FIG. 4, there are three second virtual objects within the perception range of the first virtual object. A threat warning control 411 indicates a relative direction of a second virtual object 401, a threat warning control 412 indicates a relative direction of a second virtual object 402, and a threat warning control 413 indicates a relative direction of a second virtual object 403.

The visible range of the first virtual object is a range of a virtual scene that can be photographed by the camera model from the perspective of the first virtual object. The perception range of the first virtual object is a range in which the virtual object can perform threat perception, and a perception range is greater than the visible range.

The visible range, the perception range, and the threat warning range are virtual ranges configured for simulating perception of human beings. The visible range is configured for simulating a range of visual observation of human beings. The perception range is configured for simulating a range that human beings can perceive/sense (e.g., by hearing, smelling, etc.). The threat warning range is between the visible range and the perception range, and is configured for simulating a range that other objects (such as human beings and monsters) can pose a threat to the human beings.

Shapes of the visible range, the perception range, and the threat warning range may be related to a manner of presenting a field of view of the virtual object in the virtual environment. The first-person perspective and the third-person perspective are used as examples, and the foregoing range may be a shape similar to a sector. A God's perspective is used as an example, and the foregoing range may be a shape similar to a circle.

In some embodiments, the visible range, the perception range, and the threat warning range are circular areas, representing circular areas centering on the first virtual object in a top-view plane of the virtual scene, and the threat warning range is an annular area between the visible range and the perception range. For example, when the visible range of the first virtual object is a circular area with a radius of 20 m, and the perception range of the first virtual object is a circular area with a radius of 100 m, the threat warning range is an annular area with a radius of 20 m to 100 m.

In some embodiments, the visible range, the perception range, and the threat warning range are sector areas, representing sector areas in the same direction centering on the first virtual object in the top-view plane of the virtual scene, and the threat warning range is a sector area between the visible range and the perception range. Sector angles of the three ranges are theoretically the same, and the sector angle may be close to a field of view angle of human beings.

Because the threat warning range is greater than the visible range and is less than the perception range, an occasion of threat warning is more proper, and a case in which people can perceive a possible threat in an actual scene is better simulated.

The camp refers to a camp team formed by a plurality of virtual objects having a teammate relationship. The second virtual object may belong to a neutral camp, for example, a neutral non-player character (NPC) or a wild monster in the virtual scene, or may belong to an opposing camp. Therefore, the second virtual object may launch an attack on the first virtual object, which is threatening. In this embodiment of the present disclosure, the position of the second virtual object within the threat warning range is indicated by using the threat warning control.

In some embodiments, the terminal detects, in real time, whether the second virtual object exists within the threat warning range. In response to that the second virtual object is within the threat warning range, the terminal displays the threat warning control, and in response to that the second virtual object is not within the threat warning range, the terminal does not display the threat warning control.

In some embodiments, the threat warning control may indicate the position of the second virtual object within the threat warning range in a plurality of forms.

In one embodiment, the threat warning control is a control in a form of an arrow, and the terminal indicates a relative direction (relative to the current position of the first virtual object) of the second virtual object within the threat warning range by using an indication direction of the arrow.

In another embodiment, the threat warning control is a control in a form of a line, and the terminal indicates the relative direction of the second virtual object by displaying a connection line between the first virtual object and the second virtual object.

Operation 203: Display a threat object model in the virtual scene image in response to a trigger operation on the threat warning control, the threat object model representing attribute information of the second virtual object.

In some embodiments, the attribute information may include a status value of the second virtual object, for example, skill points, an ammunition count, health points, or a stamina value of the second virtual object, or may include capability information of the second virtual object, for example, a character level or an empirical value.

The threat object model is generated by the terminal based on the attribute information of the second virtual object. Because the second virtual object may have a plurality of different attributes, to enable the user to have an intuitive understanding of the attribute information of the second virtual object, the terminal displays attribute information of different attributes in different forms. For example, the terminal displays a survival status of the second virtual object by using a color of the threat object model, and displays a skill status of the second virtual object by using a size of the threat object model.

In one embodiment, the threat object model is displayed in the virtual scene image as a virtual shadow of the second virtual object, and has an outline feature of the second virtual object. The threat object model may include an image (e.g., an image that shows the outline of the second virtual object), and/or a text (e.g., a text showing health points of the second virtual object).

The threat object model may display all attribute information of the second virtual object, or may display some attributes of the second virtual object. This is not limited in this embodiment of the present disclosure.

In some embodiments, in response to that it is difficult for the terminal to intuitively represent the attribute information of the second virtual object by using the threat object model, the terminal may display the attribute information of the second virtual object in another manner. For example, a level of the second virtual object is displayed around the threat object model in a form of text.

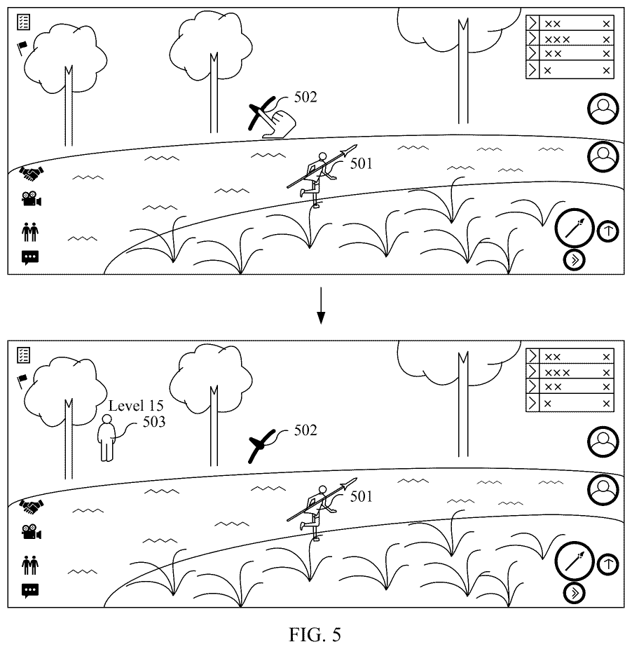

For example, as shown in FIG. 5, in response to that the second virtual object enters a threat perception warning range of a first virtual object 501, the terminal displays a threat warning control 502 in the virtual scene image, and then in response to a trigger operation on the threat warning control 502, the terminal displays a threat object model 503 in the virtual scene image. A text at an upper part of the threat object model shows that the level of the second virtual object is level 15.

In conclusion, in this embodiment of the present disclosure, in response to that the second virtual object enters the threat warning range, the terminal indicates the position of the second virtual object within the threat warning range by displaying the threat warning control. Further, in response to that the threat warning control is triggered, the terminal displays the threat object model that represents the attribute information of the second virtual object, and the user obtains attribute information of the second virtual object within a field of view with no need to manipulate the first virtual object to approach the second virtual object, thereby simplifying an obtaining process of virtual object information, and improving information obtaining efficiency. In addition, the user can make a strategic decision in advance based on display information, thereby effectively avoiding risks, and improving engagement efficiency of the first virtual object in a case of preparing for engagement.

In some embodiments, the terminal first generates the threat object model, determines a target display position of the threat object model, and then displays the threat object model at the target display position.

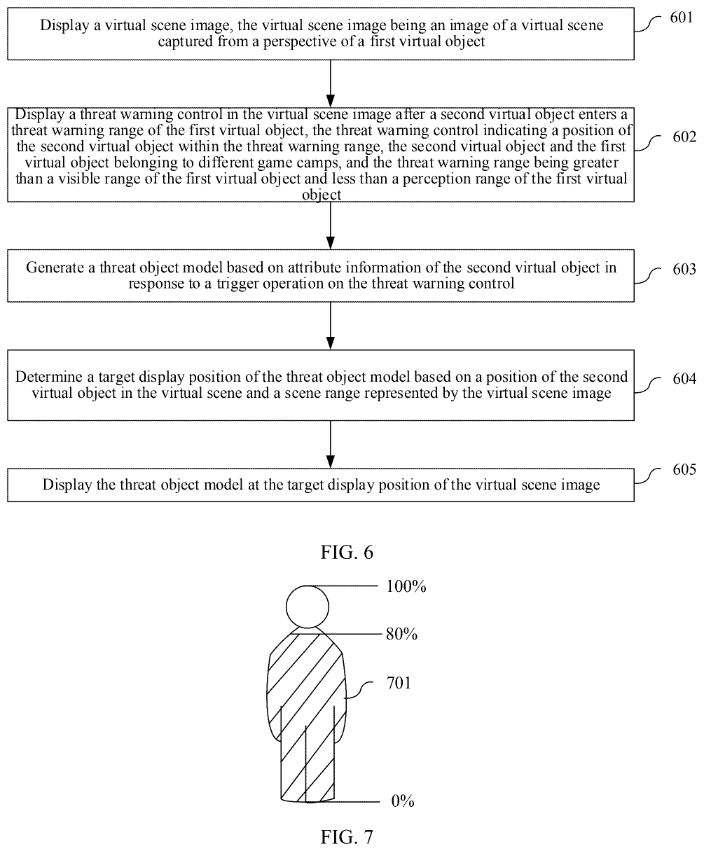

FIG. 6 is a flowchart of an information display method for a virtual object according to another exemplary embodiment of the present disclosure. The method includes the following operations.

Operation 601: Display a virtual scene image, the virtual scene image being an image of a virtual scene captured from a perspective of a first virtual object.

Operation 602: Display a threat warning control in the virtual scene image after a second virtual object enters a threat warning range of the first virtual object, the threat warning control indicating a position of the second virtual object within the threat warning range, the second virtual object and the first virtual object belonging to different game camps, and the threat warning range being greater than a visible range of the first virtual object and less than a perception range of the first virtual object.

For specific implementations of operations 601 and 602, refer to operations 201 and 202. This is not limited in this embodiment.

Operation 603: Generate a threat object model based on attribute information of the second virtual object in response to a trigger operation on the threat warning control.

In some embodiments, the threat object model is displayed in a form of an outline of the second virtual object.

In some embodiments, a background color of an outline of the threat object model may be colorless, and then the attribute information of the second virtual object is displayed based on a fill proportion of a visible color.

In some embodiments, the terminal first determines status integrity of the second virtual object based on the attribute information of the second virtual object, where the status integrity represents an integrity degree of a current status of the second virtual object, then determines a color fill proportion of the threat object model based on the status integrity, where the color fill proportion is positively correlated to the status integrity, and finally performs color filling on the threat object model based on the color fill proportion.

The status of the second virtual object is configured for identifying a dimension in which the second virtual object threatens another virtual object in a virtual scene. A higher integrity degree of the status indicates a greater threat to the another virtual object. The status of the second virtual object may be described by using one or more pieces of attribute information of the second virtual object.

In one embodiment, the terminal performs color filling in a vertical direction of the threat object model based on the color fill proportion from bottom to top.

In some embodiments, the current status of the second virtual object may include a weapon status, a skill status, and a health status. A status type of the second virtual object is not limited in this embodiment of the present disclosure.

In one embodiment, the terminal determines the color fill proportion of the threat object model based on an integrity degree of one of the foregoing statuses.

In another embodiment, the terminal determines the color fill proportion of the threat object model based on a composite status integrity degree of the second virtual object. For example, an ammunition remainder of the second virtual object is 80%, a skill charge level is 60%, and health points are 100%. Weighted average calculation is performed on the three statuses, to obtain a composite status integrity degree of 80%, to determine that the color fill proportion is 80%.

For example, a schematic diagram of color filling of the threat object model is shown in FIG. 7. The terminal performs color filling on a threat object model 701 from bottom to top. In response to that the status integrity is 80%, 80% of an outline of the threat object model is filled.

Further, in addition to the integrity degree of the current status of the second virtual object, the threat object model may represent a threat degree of the second virtual object to the first virtual object.

In some embodiments, the terminal determines the threat degree of the second virtual object to the first virtual object based on attribute information of the first virtual object and the attribute information of the second virtual object, and then performs color filling on the threat object model based on the color fill proportion by using a prompt color corresponding to the threat degree. For example, in a low-risk case, filling is performed by using green; in a medium-risk case, the threat object model changes from green to yellow; and in a high-risk case, the threat object model changes from yellow to red.

In one embodiment, the terminal calculates, based on a difference between the attribute information of the first virtual object and the attribute information of the second virtual object, the threat degree of the second virtual object to the first virtual object. In response to that the attribute information of the second virtual object exceeds the attribute information of the first virtual object, and the difference between the attribute information of the second virtual object and the attribute information of the first virtual object exceeds a difference threshold, the threat degree of the second virtual object is at a high level. In response to that the attribute information of the second virtual object does not exceed the attribute information of the first virtual object, and the difference between the attribute information of the second virtual object and the attribute information of the first virtual object exceeds the difference threshold, the threat degree of the second virtual object is at a low level. In response to that the difference between the attribute information of the second virtual object and the attribute information of the first virtual object does not exceed the difference threshold, the threat degree of the second virtual object is at a medium level. The attribute information of the first virtual object and the attribute information of the second virtual object may be an independent data indicator, for example, health points, or may be a comprehensive data indicator, for example, a comprehensive indicator of health points and levels.

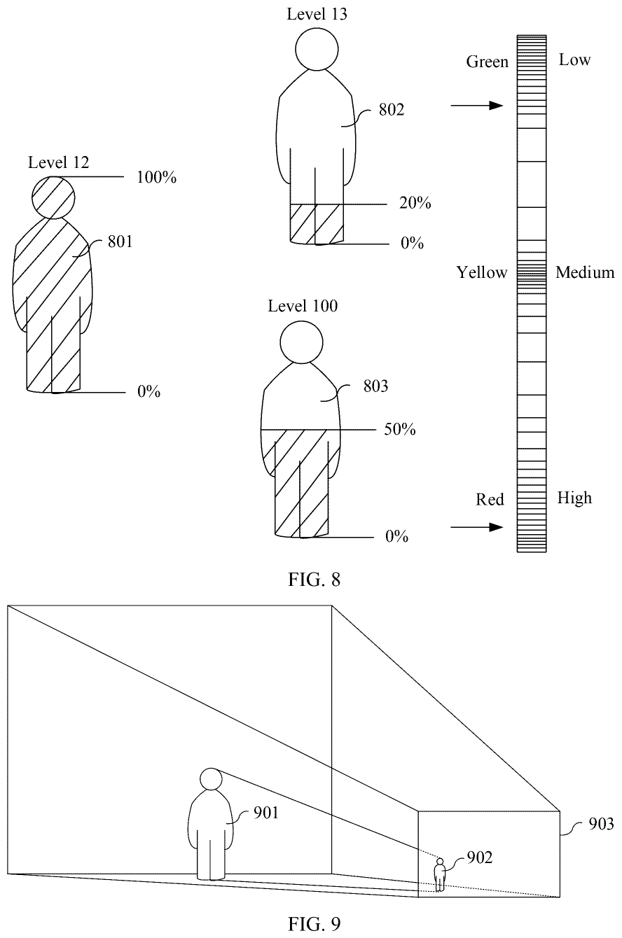

For example, as shown in FIG. 8, in response to that a threat object model 801 represents that a level of the first virtual object is level 12, and health points are 100%, and a threat object model 802 represents that a level of the second virtual object is level 13, and health points are 20%, the terminal sets a health points weight to 10, a level weight to 1, and a difference threshold to 5. Subsequently, it is determined through weighted calculation that the attribute information of the first virtual object exceeds the attribute information of the second virtual object, and the difference between the attribute information of the second virtual object and the attribute information of the first virtual object exceeds the difference threshold. Therefore, the threat degree of the second virtual object is relatively low, and the terminal fills the threat object model 802 in green. Similarly, in response to that the threat object model 801 represents that the level of the first virtual object is level 12, and health points are 100%, and a threat object model 803 represents that the level of the second virtual object is level 100, and health points are 50%, the attribute information of the first virtual object does not exceed the attribute information of the second virtual object, and the difference between the attribute information of the second virtual object and the attribute information of the first virtual object exceeds the difference threshold, the terminal determines that the threat degree of the second virtual object is relatively high, and the terminal fills the threat object model with red.

Operation 604: Determine a target display position of the threat object model based on a position of the second virtual object in the virtual scene and a scene range represented by the virtual scene image.

The virtual scene image is photographed from the perspective of the first virtual object, and the position of the first virtual object in the virtual scene may be directly indicated. Therefore, based on this, a relative direction of the second virtual object relative to the first virtual object in the virtual scene may be accurately obtained with reference to the position of the second virtual object in the virtual scene. The target display position may be determined in the relative direction, to indicate a direction of the second virtual object to the user controlling the first virtual object. Further, when the second virtual object has entered a field of view of the first virtual object, in addition to indicating the relative direction of the second virtual object to the user, the target display position may further indicate a position of the second virtual object in the virtual scene image.

A scene range represented by the virtual scene image is a scene range that can be photographed by a camera model. Because a range of a scene that can be photographed by the camera model is limited, the second virtual object may be located in the virtual scene image or may be located outside the virtual scene image.

In some embodiments, to optimize a rendering effect of the virtual scene image, the terminal may render only a virtual object within a view frustum according to a view frustum cropping algorithm.

In some embodiments, the terminal determines, based on the position of the second virtual object in the virtual scene, whether the second virtual object is located within the virtual scene image.

In one embodiment, the terminal calculates a spatial range determined by six faces of a view frustum in front of the camera model. In response to that the position of the second virtual object in the virtual scene is inside the view frustum, the second virtual object is located within the virtual scene image, and in response to that the position of the second virtual object in the virtual scene is outside the view frustum, the second virtual object is located outside the virtual scene image.

In some embodiments, this operation may include the following two cases.

Case 1: Determine a projection position of the second virtual object in the virtual scene image as the target display position of the threat object model in response to that the position of the second virtual object in the virtual scene is within the scene range represented by the virtual scene image.

In one embodiment, the terminal determines the target display position of the threat object model in the virtual scene image based on the position of the second virtual object in the virtual scene and a mapping relationship between each position inside the view frustum and each point on the virtual scene image.

For example, as shown in FIG. 9, a position of a second virtual object 901 in a virtual scene is within a scene range represented by a virtual scene image 903. The second virtual object 901 is projected, to determine a target display position of a threat object model 902 in the virtual scene image 903.

Case 2: Determine a target image edge of the virtual scene image in response to that the position of the second virtual object in the virtual scene is outside the scene range represented by the virtual scene image, the target image edge being a image edge closest to the projection position of the second virtual object in image edges of the virtual scene image; and determine the target image edge as the target display position of the threat object model.

In one embodiment, the terminal first vertically projects the second virtual object to a view frustum plane (a plane in which the virtual scene image is located), then obtains a projection center point, calculates vertical distances between the projection center point and four image edges of the virtual scene image, to determine a image edge having a shortest vertical distance to the projection center point as the target image edge, and then displays the threat object model at the target image edge.

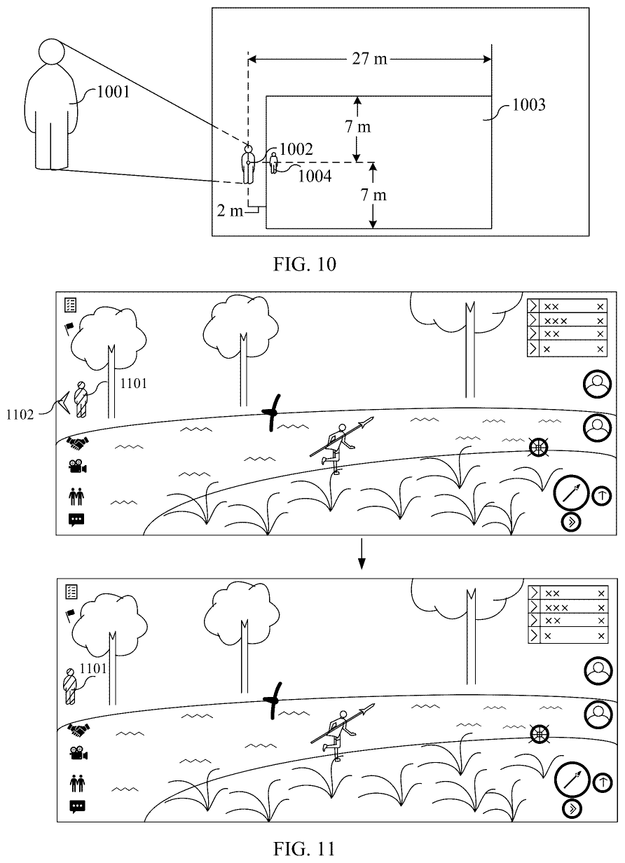

For example, as shown in FIG. 10, in the virtual scene, a projection center point 1002 of a second virtual object 1001 has a distance of 2 m to a left side edge of a virtual scene image 1003, a distance of 27 m to a right side edge of the virtual scene image 1003, a distance of 7 m to an upper side edge of the virtual scene image 1003, and a distance of 7 m to a lower side edge of the virtual scene image 1003. The terminal determines that the projection center point 1002 of the second virtual object 1001 is closest to the left side edge of the virtual scene image 1003, and displays a threat object model 1004 at the left side edge of the virtual scene image 1003.

In some embodiments, the terminal displays an arrow identifier between the target image edge and the threat object model in response to that the position of the second virtual object in the virtual scene is outside the scene range represented by the virtual scene image, the arrow identifier representing that the second virtual object is outside the virtual scene image. Displaying of the arrow identifier is stopped in response to that the second virtual object moves into the scene range represented by the virtual scene image.

For example, as shown in FIG. 11, in response to that the position of the second virtual object in the virtual scene is outside the scene range represented by the virtual scene image, the terminal displays an arrow identifier 1102 between a left side edge of the virtual scene image and a threat object model 1101, to indicate that the second virtual object is located at a left side position outside the virtual scene image. In response to that the second virtual object moves into the scene range represented by the virtual scene image, the terminal displays the threat object model 1101 within the virtual scene image, to indicate that the second virtual object is located at a display position of the threat object model 1101 within the virtual scene image.

Operation 605: Display the threat object model at the target display position of the virtual scene image.

In addition to displaying the threat warning control in the virtual scene image, the target display position may further be determined in the virtual scene image based on the position of the second virtual object. Because the target display position may accurately indicate the relative direction of the second virtual object relative to the first virtual object, the threat object model displayed at the target display position may play a more intuitive guiding role, thereby effectively reducing operation costs of the user.

In one embodiment, in response to that the position of the second virtual object in the virtual scene is within the scene range represented by the virtual scene image, the threat object model is displayed as a virtual shadow of the second virtual object in the virtual scene image, and has an outline feature of the second virtual object. In response to that the position of the second virtual object in the virtual scene is outside the scene range represented by the virtual scene image, the threat object model is displayed as an icon similar to the virtual shadow of the second virtual object in the virtual scene image.

In the foregoing embodiment, the threat object model visually displays the status integrity of the second virtual object based on the color fill proportion, so that the user can learn about attribute information represented by the threat object model with no need to get close to the second virtual object, thereby improving obtaining efficiency of the attribute information.

Further, the threat object model represents the threat degree of the second virtual object by using a prompt color, to save a process of determining the threat degree by the user based on the attribute information, so that the first virtual object can respond quickly in the face of the threat.

To clearly determine a specific position of the second virtual object, the terminal uses different display manners for the threat object model of the second virtual object in the virtual scene image and the threat object model of the second virtual object outside the virtual scene image, to display the position of the second virtual object in the virtual scene simply and clearly, thereby improving obtaining efficiency of the relative direction of the second virtual object.

In some embodiments, to enable the user to easily understand a position of the second virtual object that is indicated by the threat warning control within the threat warning range, the terminal first determines a relative direction between the second virtual object and the first virtual object, and then displays the threat warning control at an edge position that corresponds to the relative direction and that is on a target circular area in the virtual scene image, different edge positions on the target circular area being corresponding to different directions around the first virtual object.

In some embodiments, in some scenes, to simplify display content in the virtual scene image, the target circular area is invisible in the virtual scene image.

In one embodiment, the terminal determines a relative position of the second virtual object based on coordinate positions of the second virtual object and the first virtual object in a virtual scene, then determines an edge position of the threat warning control on the target circular area based on a relative angle between the relative position (that is, the relative direction of the second virtual object) and a positive direction of the perspective of the first virtual object, and then displays the threat warning control.

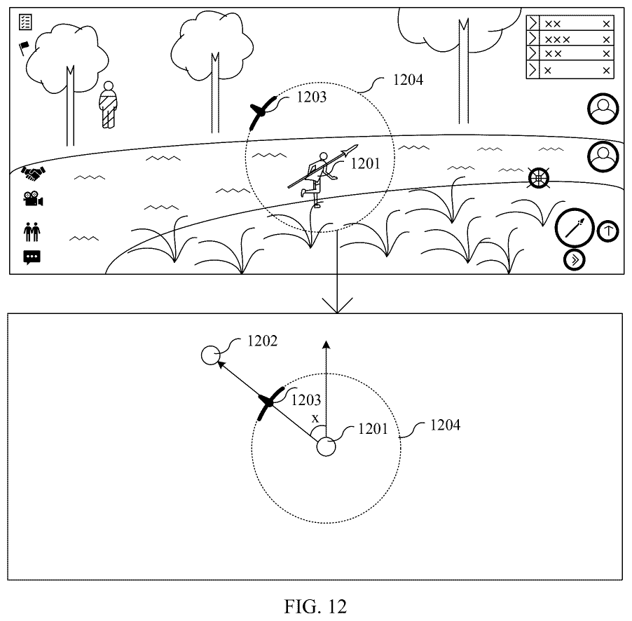

For example, as shown in FIG. 12, a positive direction of a perspective of a first virtual object 1201 is vertically upward in a virtual scene image, and a relative angle between a relative direction of a second virtual object 1202 and the positive direction of the perspective of the first virtual object 1201 is x, where x is between −180° and +180°, and an edge position of a threat warning control 1203 on a target circular area 1204 may be determined based on the angle x. The target circular area 1204 displayed by a dashed line is invisible in the virtual scene image.

Because the target circular area is in the virtual scene image, the threat warning control displayed on the target circular area can be directly detected by the user controlling the first virtual object, and a position at which the threat warning control is displayed further provides directional guidance, and can play a better role in prompt and indication.

In some embodiments, in consideration of a case that in a moving process of the first virtual object or the second virtual object, the second virtual object may leave the perception range of the first virtual object, to prevent the threat warning control from interfering with display of other content in the virtual scene image, the terminal stops displaying the threat object model and the threat warning control in response to that the second virtual object leaves the perception range of the first virtual object.

In addition, in consideration of a case that the second virtual object may enter the perception range of the first virtual object again after leaving the perception range of the first virtual object, to ensure that the user can quickly learn about the attribute information of the second virtual object in a process of manipulating the first virtual object to move, the terminal retains the threat object model in response to that the second virtual object enters the threat warning range again, and duration of leaving the threat warning range does not reach a duration threshold. That is, the terminal displays the threat warning control and the threat object model in the virtual scene image, and the user does not need to trigger the threat warning control again to display the threat object model. In response to that the second virtual object enters the threat warning range again, and the duration of leaving the threat warning range reaches the duration threshold, the terminal displays the threat warning control in the virtual scene image, and then displays the threat object model in the virtual scene image in response to a trigger operation on the threat warning control.

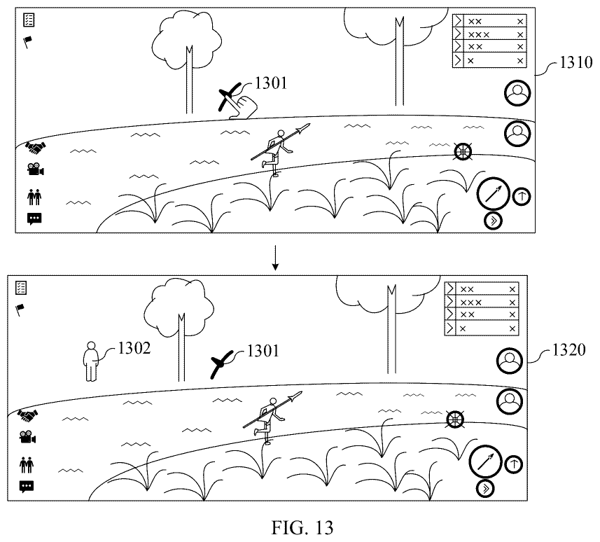

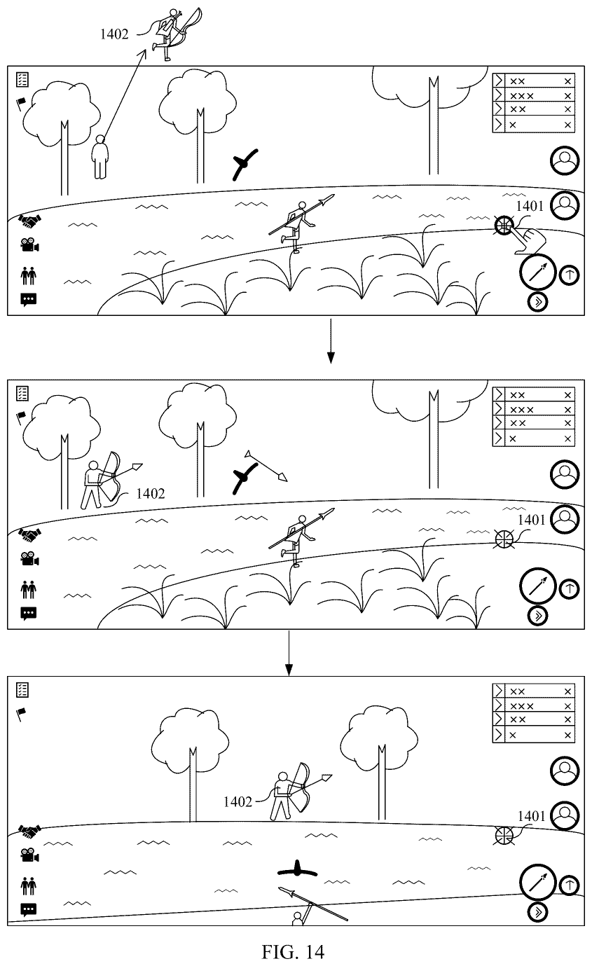

For example, as shown in FIG. 13, the duration threshold is 1 min. In response to that the second virtual object enters the perception range again after leaving the perception range for 80 s, the terminal displays a virtual scene image 1310, and the terminal displays a threat warning control 1301 in the virtual scene image 1310. In response to a trigger operation on the threat warning control 1301, the terminal changes from displaying the virtual scene image 1310 to displaying a virtual scene image 1320, and displays a threat object model 1302 and the threat warning control 1301 in the virtual scene image 1320. In response to that the second virtual object enters the perception range again after leaving the perception range for 30 s, the terminal displays the virtual scene image 1320, and displays the threat warning control 1301 and the threat object model 1302 in the virtual scene image 1320.

In the foregoing embodiment, the terminal determines the display position and the indication direction of the threat warning control on the target circular area, so that the user quickly learns about the relative position of the second virtual object. In addition, the terminal limits display and stop display occasions of the threat object model and the threat warning control. The threat object model and the threat warning control can be automatically displayed or automatically stopped to be displayed with no need for the user to repeatedly enable or disable display in a short time, thereby simplifying operating steps.

In consideration of a case that the user cannot determine an attack range or an attack occasion of the second virtual object, and in response to that the second virtual object actively launches an attack on the first virtual object, the first virtual object may miss a retreat or attack occasion due to an untimely response, the terminal may further display an object lock control in the virtual scene image, and quickly respond to an attack behavior of the second virtual object by locking the second virtual object.

In some embodiments, the terminal displays the object lock control in the virtual scene image, and then sets the second virtual object to a locked state in response to a trigger operation on the object lock control. In the locked state, the terminal locks a perspective on the second virtual object in response to that the second virtual object launches an attack, the perspective of the first virtual object being automatically adjusted to the position of the second virtual object after the perspective is locked.

In some embodiments, the object lock control may be displayed in response to that the terminal displays the threat warning control, or may be displayed in response to that the terminal displays the threat object model.

Regarding implementation of perspective locking, in one embodiment, the terminal obtains the position of the second virtual object in the virtual scene in real time, and then automatically adjusts a photographing perspective based on the position of the second virtual object relative to the first virtual object.

In some embodiments, after the second virtual object is set to the locked state, the first virtual object may automatically prepare for engagement. For example, in the locked state, the first virtual object automatically performs ammunition filling, and switches to a defense posture, to improve counterattack efficiency of the first virtual object.

For example, as shown in FIG. 14, the terminal displays an object lock control 1401 in the virtual scene image. After the user triggers the object lock control 1401, the terminal sets a second virtual object 1402 to the locked state. In response to that the second virtual object 1402 launches an attack, the terminal automatically switches perspectives, and displays the second virtual object 1402 as the center of the virtual scene image.

In some embodiments, there may be a plurality of second virtual objects within the perception range of the first virtual object, or there may be only one second virtual object.

In response to that there are a plurality of second virtual objects within the perception range of the first virtual object, in one embodiment, the terminal displays a plurality of threat warning controls to indicate relative positions of different second virtual objects. In response to that the threat warning control is triggered, the terminal displays the threat object model of the second virtual object indicated by the threat warning control, and then sets the second virtual object to the locked state in response to a trigger operation on the object lock control. The plurality of second virtual objects may be simultaneous locked by repeatedly performing the foregoing operations. In response to that the first virtual object is attacked, the terminal locks the perspective on the second virtual object that launches the attack.

In response to that there is only one second virtual object within the perception range of the first virtual object, and the second virtual object is not set to the locked state, in response to that the second virtual object launches an attack, the terminal may also lock the perspective on the second virtual object.

In some embodiments, in the locked state, in response to that the second virtual object launches an attack, the terminal highlights the threat warning control corresponding to the second virtual object. For example, the terminal enlarges the threat warning control corresponding to the second virtual object for display. For another example, the terminal changes a display color of the threat warning control corresponding to the second virtual object.

In some embodiments, in response to that the second virtual object in the locked state does not launch an attack on the first virtual object, the first virtual object may actively launch an attack on the second virtual object.

In some embodiments, attack skills of the first virtual object include a skill for which a release position is specified and a skill for which a release position is not specified. The skill for which a release position is specified is released based on a release position selected by the user. For example, the user selects a skill release direction by operating a joystick, and then the skill is released in the direction selected by the user. The skill for which a release position is not specified is automatically released to the second virtual object based on the position of the second virtual object.

In this embodiment of the present disclosure, in the locked state, in response to the target skill release operation, the terminal controls the first virtual object to release skills to the position of the second virtual object, the target skill release operation being a skill release operation without specifying a release direction.

In the locked state, because the second virtual object may not initiate an attack behavior, or the first virtual object may retreat in a defense posture, in some embodiments, the first virtual object may freely move in the locked state. In addition, in response to that the second virtual object is defeated, the terminal does not need to continue to lock the second virtual object.

In some embodiments, the terminal unlocks the locked state in response to that the second virtual object leaves the perception range of the first virtual object, or the second virtual object is defeated.

In some embodiments, in consideration of a case that the first virtual object may move to the second virtual object in the locked state in a free-moving process, that is, the second virtual object may enter the visible range from the perception range, after entering the visible range, the threat object model in the virtual scene image needs to be switched to a specific image of the second virtual object.

In one embodiment, progressive transparency processing is performed on the threat object model in response to that the second virtual object enters the visible range of the first virtual object.

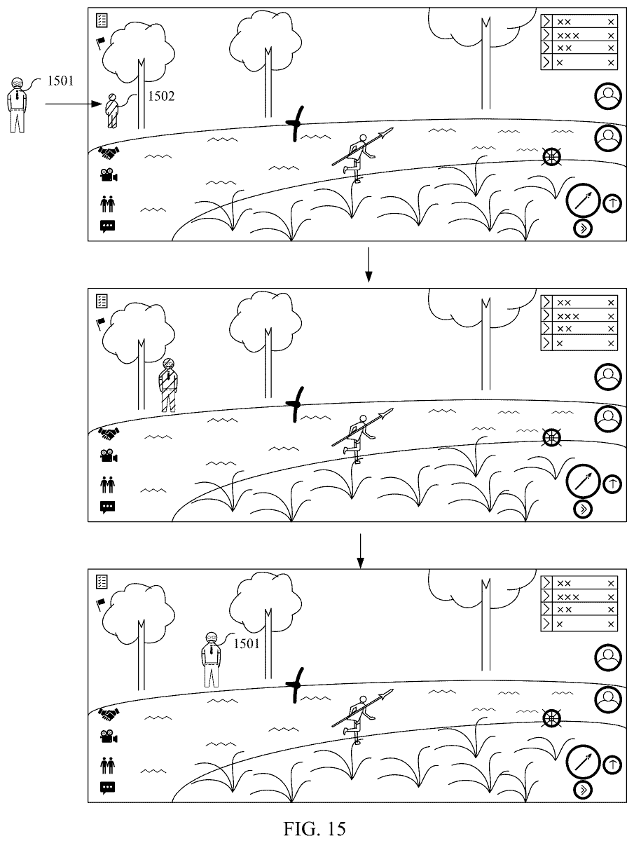

For example, as shown in FIG. 15, in response to that a second virtual object 1501 does not enter the visible range, a threat object model 1502 is a red-filled outline. After the second virtual object 1501 enters the visible range, the threat object model 1502 covers the second virtual object 1501, and changes with movement of the second virtual object 1501. Within 3 s after the second virtual object 1501 enters the visible range, the threat object model 1502 gradually becomes transparent, and the second virtual object 1501 at the position of the threat object model 1502 within the visible range is displayed.

In the foregoing embodiment, the terminal provides a locking function for the second virtual object by displaying the object lock control, to quickly respond to an attack behavior of the second virtual object in the locked state. This avoids a process in which the user frequently switches perspectives, and simplifies operating steps of the user on the first virtual object.

In some embodiments, after a threat degree of the second virtual object to the first virtual object is determined, the terminal may display, in the virtual scene image, a threat warning control using a prompt color corresponding to the threat degree. That is, in response to that the second virtual object enters the threat warning range, the terminal displays, based on the threat degree of the second virtual object, the threat warning control in a corresponding prompt color.

In the foregoing embodiment, the user learns about the threat degree of the second virtual object with no need to trigger the threat warning control to display the threat object model, thereby simplifying operating steps, and improving efficiency of obtaining virtual object information by the user.

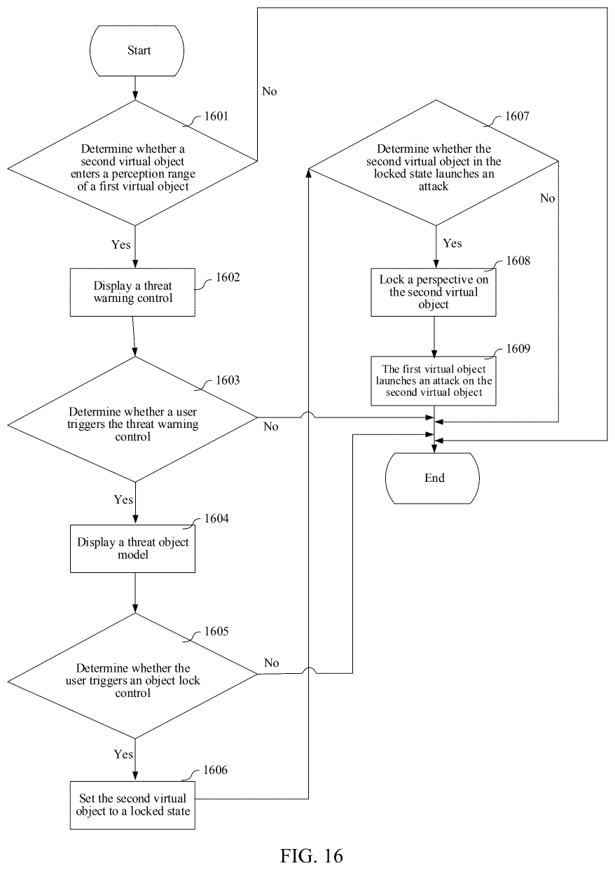

FIG. 16 is a flowchart of a display process of virtual object information according to an exemplary embodiment of the present disclosure. The process includes the following operations.

Operation 1601: Determine whether a second virtual object enters a perception range of a first virtual object.

Operation 1602: Display a threat warning control in response to that the second virtual object enters the perception range of the first virtual object.

Operation 1603: Determine whether a user triggers the threat warning control.

Operation 1604: Display a threat object model in response to that the user triggers the threat warning control.

Operation 1605: Determine whether the user triggers an object lock control.

Operation 1606: Set the second virtual object to a locked state in response to that the user triggers the object lock control.

Operation 1607: Determine whether the second virtual object in the locked state launches an attack.

In response to that the second virtual object in the locked state does not initiate an attack on the first virtual object, operation 1609 may be performed, or retreat may be selected.

In response to that the second virtual object in the locked state launches an attack on the first virtual object, operation 1608 is performed.

Operation 1608: Lock a perspective on the second virtual object in response to that the second virtual object in the locked state launches an attack on the first virtual object.

Operation 1609: The first virtual object launches an attack on the second virtual object.

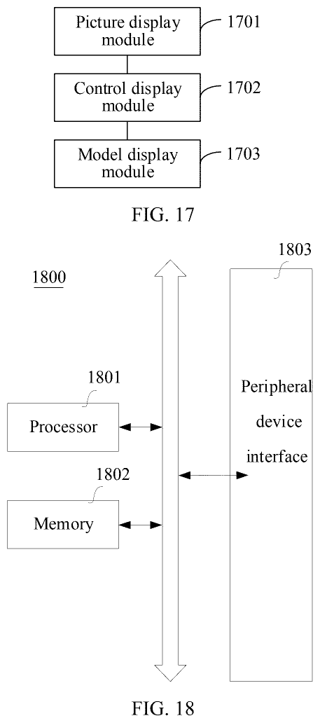

FIG. 17 is a block diagram of a structure of an information display apparatus for a virtual object according to an exemplary embodiment of the present disclosure. The apparatus includes:
an image display module 1701, configured to display a virtual scene image, the virtual scene image being an image of a virtual scene captured from a perspective of a first virtual object;
a control display module 1702, configured to display a threat warning control in the virtual scene image after a second virtual object enters a threat warning range of the first virtual object, the threat warning control indicating a position of the second virtual object within the threat warning range, the second virtual object and the first virtual object belonging to different game camps, and the threat warning range being greater than a visible range of the first virtual object and less than a perception range of the first virtual object; and
a model display module 1703, configured to display a threat object model in the virtual scene image in response to a trigger operation on the threat warning control, the threat object model representing attribute information of the second virtual object.

In some embodiments, the model display module 1703 is further configured to:
generate the threat object model based on the attribute information of the second virtual object;
determine a target display position of the threat object model based on a position of the second virtual object in the virtual scene and a scene range represented by the virtual scene image; and
display the threat object model at the target display position of the virtual scene image.

In some embodiments, the model display module 1703 is further configured to:
determine status integrity of the second virtual object based on the attribute information of the second virtual object, the status integrity representing an integrity degree of a current status of the second virtual object;
determine a color fill proportion of the threat object model based on the status integrity, the color fill proportion being positively correlated to the status integrity; and
perform color filling on the threat object model based on the color fill proportion.

In some embodiments, the model display module 1703 is further configured to:
determine a threat degree of the second virtual object to the first virtual object based on attribute information of the first virtual object and the attribute information of the second virtual object; and
the performing color filling on the threat object model based on the color fill proportion includes:
perform color filling on the threat object model based on the color fill proportion by using a prompt color corresponding to the threat degree.

In some embodiments, the model display module 1703 is further configured to:
display, in the virtual scene image, the threat warning control in the prompt color corresponding to the threat degree.

In some embodiments, the model display module 1703 is further configured to:
determine a projection position of the second virtual object in the virtual scene image as the target display position of the threat object model in response to that the position of the second virtual object in the virtual scene is within the scene range represented by the virtual scene image; and
determine a target image edge of the virtual scene image in response to that the position of the second virtual object in the virtual scene is outside the scene range represented by the virtual scene image, the target image edge being a image edge closest to the projection position of the second virtual object in image edges of the virtual scene image; and determine the target image edge as the target display position of the threat object model.

In some embodiments, the model display module 1703 is further configured to:
display an arrow identifier between the target image edge and the threat object model in response to that the position of the second virtual object in the virtual scene is outside the scene range represented by the virtual scene image, the arrow identifier representing that the second virtual object is outside the virtual scene image; and
stop displaying the arrow identifier in response to that the second virtual object moves into the scene range represented by the virtual scene image.

In some embodiments, the control display module 1702 is further configured to:
determine a relative direction between the second virtual object and the first virtual object; and
display the threat warning control at an edge position that corresponds to the relative direction and that is on a target circular area in the virtual scene image, different edge positions on the target circular area being corresponding to different directions around the first virtual object.

In some embodiments, the apparatus further includes a locking module, configured to:
display an object lock control in the virtual scene image;
set the second virtual object to a locked state in response to a trigger operation on the object lock control; and
in the locked state, lock a perspective on the second virtual object in response to that the second virtual object launches an attack, the perspective of the first virtual object being automatically adjusted to the position of the second virtual object after the perspective is locked.

In some embodiments, the locking module is further configured to:
in the locked state, control, in response to a target skill release operation, the first virtual object to release skills to the position of the second virtual object, the target skill release operation being a skill release operation without specifying a release direction.

In some embodiments, the locking module is further configured to:
release the locked state in response to that the second virtual object leaves the perception range of the first virtual object, or the second virtual object is defeated.

In some embodiments, the locking module is further configured to:
in the locked state, highlight, in response to that the second virtual object launches an attack, the threat warning control corresponding to the second virtual object.

In some embodiments, the control display module 1702 and the model display module 1703 are further configured to:
stop displaying the threat object model and the threat warning control in response to that the second virtual object leaves the perception range of the first virtual object;
display the threat warning control in the virtual scene image in response to that the second virtual object enters the threat warning range again, and duration of leaving the threat warning range reaches a duration threshold; and
display the threat warning control and the threat object model in the virtual scene image in response to that the second virtual object enters the threat warning range again, and the duration of leaving the threat warning range does not reach the duration threshold.

In some embodiments, the model display module 1703 is further configured to:
perform progressive transparency processing on the threat object model in response to that the second virtual object enters the visible range of the first virtual object.

In conclusion, in this embodiment of the present disclosure, in response to that the second virtual object enters the threat warning range, the terminal indicates the position of the second virtual object within the threat warning range by displaying the threat warning control. Further, in response to that the threat warning control is triggered, the terminal displays the threat object model that represents the attribute information of the second virtual object, and the user obtains attribute information of the second virtual object within a field of view with no need to manipulate the first virtual object to approach the second virtual object, thereby simplifying an obtaining process of virtual object information, and improving information obtaining efficiency. In addition, the user can make a strategic decision in advance based on display information, thereby effectively avoiding risks, and improving engagement efficiency of the first virtual object in a case of preparing for engagement.

The apparatus provided in the foregoing embodiment is illustrated only with an example of division of the foregoing function modules. In practical applications, the foregoing functions may be allocated to and completed by different function modules based on requirements. That is, an internal structure of the apparatus is divided into different function modules to complete all or some of the functions described above. In addition, the apparatus provided in the foregoing embodiment and the method embodiment fall within a same conception. For details of an implementation process, refer to the method embodiment. Details are not described herein again.

FIG. 18 is a structural block diagram of a terminal 1800 according to an exemplary embodiment of the present disclosure. The terminal 1800 may be a portable mobile terminal, for example, a smartphone and a tablet computer. The terminal 1800 may alternatively be referred to as another name such as user equipment or a portable terminal.

Generally, the terminal 1800 includes a processor 1801 and a memory 1802.

The processor 1801 may include one or more processing cores, for example, a 4-core processor or an 8-core processor. The processor 1801 may be implemented by using at least one hardware form of a digital signal processing (DSP), a field-programmable gate array (FPGA), and a programmable logic array (PLA). The processor 1801 may also include a main processor and a coprocessor. The main processor is a processor configured to process data in an awake state, and is also referred to as a central processing unit (CPU). The coprocessor is a low power consumption processor configured to process the data in a standby state. In some embodiments, the processor 1801 may be integrated with a graphics processing unit (GPU). The GPU is configured to render and draw content that needs to be displayed on a display screen. In some embodiments, the processor 1801 may further include an artificial intelligence (AI) processor. The AI processor is configured to process computing operations correlated with machine learning.

The memory 1802 may include one or more computer-readable storage media. The computer-readable storage media may be tangible and non-transient. The memory 1802 may also include a high-speed random access memory, as well as a non-volatile memory, such as one or more disk storage devices and flash storage devices. In some embodiments, a non-transient computer-readable storage medium in the memory 1802 is configured to store at least one instruction, and the at least one instruction is executed by the processor 1801 to implement the information display method for a virtual object provided in the embodiments of the present disclosure.

In some embodiments, the terminal 1800 may alternatively include: a peripheral device interface 1803 and at least one peripheral device.

The peripheral device interface 1803 may be configured to connect at least one peripheral device related to input/output (I/O) to the processor 1801 and the memory 1802. In some embodiments, the processor 1801, the memory 1802, and the peripheral device interface 1803 are integrated on a same chip or circuit board. In some other embodiments, any one or two of the processor 1801, the memory 1802, and the peripheral device interface 1803 may be implemented on a single chip or circuit board. This is not limited in this embodiment.

A person skilled in the art may understand that the structure shown in FIG. 18 constitutes no limitation on the terminal 1800, and the terminal may include more or fewer components than those shown in the figure, or some components may be combined, or a different component deployment may be used.

In addition, an embodiment of the present disclosure further provides a storage medium, configured to store a computer program. The computer program is configured for performing the method provided in the foregoing embodiments.

An embodiment of the present disclosure further provides a computer program product including a computer program, and when the computer program product is run on a computer, the computer is enabled to perform the method provided in the foregoing embodiments.

A person skilled in the art may be aware that in the foregoing one or more examples, functions described in the embodiments of the present disclosure may be implemented by using hardware, software, firmware, or any combination thereof. When being implemented by using software, the functions can be stored in a computer-readable storage medium or can be used as one or more instructions or codes in the computer-readable storage medium for transmission. The computer-readable storage medium includes a computer storage medium and a communication medium, where the communication medium includes any medium that enables a computer program to be transmitted from one place to another. The storage medium may be any available medium accessible to a general-purpose or dedicated computer.

The foregoing descriptions are merely exemplary embodiments of the present disclosure, but are not intended to limit the present disclosure. Any modification, equivalent replacement, or improvement made within the spirit and principle of the present disclosure shall fall within the protection scope of the present disclosure.

What is claimed is:

1. An information display method for a virtual object, performed by a terminal device, the method comprising:
displaying a virtual scene image, the virtual scene image being an image of a virtual scene captured from a perspective of a first virtual object;
displaying a threat warning control in the virtual scene image after a second virtual object enters a threat warning range of the first virtual object, the threat warning control indicating a position of the second virtual object within the threat warning range, the second virtual object and the first virtual object belonging to different game camps, and the threat warning range being greater than a visible range of the first virtual object and less than a perception range of the first virtual object; and
displaying a threat object model in the virtual scene image in response to a trigger operation on the threat warning control, the threat object model representing attribute information of the second virtual object.

2. The method according to claim 1, wherein the displaying a threat object model in the virtual scene image comprises:
generating the threat object model based on the attribute information of the second virtual object;
determining a target display position of the threat object model based on a position of the second virtual object in the virtual scene and a scene range represented by the virtual scene image; and
displaying the threat object model at the target display position of the virtual scene image.

3. The method according to claim 2, wherein the generating the threat object model based on the attribute information of the second virtual object comprises:
determining status integrity of the second virtual object based on the attribute information of the second virtual object, the status integrity representing an integrity degree of a current status of the second virtual object;
determining a color fill proportion of the threat object model based on the status integrity, the color fill proportion being positively correlated to the status integrity; and
performing color filling on the threat object model based on the color fill proportion.

4. The method according to claim 3, further comprising:
determining a threat degree of the second virtual object to the first virtual object based on attribute information of the first virtual object and the attribute information of the second virtual object; and
the performing color filling on the threat object model based on the color fill proportion comprises:
performing color filling on the threat object model based on the color fill proportion by using a prompt color corresponding to the threat degree.

5. The method according to claim 4, wherein the displaying a threat warning control in the virtual scene image comprises:
displaying, in the virtual scene image, the threat warning control in the prompt color corresponding to the threat degree.

6. The method according to claim 2, wherein the determining a target display position of the threat object model based on a position of the second virtual object in the virtual scene and a scene range represented by the virtual scene image comprises:
determining a projection position of the second virtual object in the virtual scene image as the target display position of the threat object model in response to that the position of the second virtual object in the virtual scene is within the scene range represented by the virtual scene image; and
determining a target image edge of the virtual scene image in response to that the position of the second virtual object in the virtual scene is outside the scene range represented by the virtual scene image, the target image edge being an image edge closest to the projection position of the second virtual object in image edges of the virtual scene image; and determining the target image edge as the target display position of the threat object model.

7. The method according to claim 6, further comprising:
displaying an arrow identifier between the target image edge and the threat object model in response to that the position of the second virtual object in the virtual scene is outside the scene range represented by the virtual scene image, the arrow identifier representing that the second virtual object is outside the virtual scene image; and
stopping displaying the arrow identifier in response to that the second virtual object moves into the scene range represented by the virtual scene image.

8. The method according to claim 1, the displaying a threat warning control in the virtual scene image comprises:
determining a relative direction between the second virtual object and the first virtual object; and
displaying the threat warning control at an edge position that corresponds to the relative direction and that is on a target circular area in the virtual scene image, different edge positions on the target circular area corresponding to different directions around the first virtual object.

9. The method according to claim 1, further comprising:
displaying an object lock control in the virtual scene image;
setting the second virtual object to a locked state in response to a trigger operation on the object lock control; and
in the locked state, locking the perspective on the second virtual object in response to that the second virtual object launches an attack, the perspective of the first virtual object being automatically adjusted to the position of the second virtual object after the perspective is locked.

10. The method according to claim 9, further comprising:
in the locked state, controlling, in response to a target skill release operation, the first virtual object to release skills to the position of the second virtual object, the target skill release operation being a skill release operation without specifying a release direction.

11. The method according to claim 9, further comprising:
releasing the locked state in response to that the second virtual object leaves the perception range of the first virtual object, or the second virtual object is defeated.

12. The method according to claim 9, further comprising:
in the locked state, highlighting, in response to that the second virtual object launches an attack, the threat warning control corresponding to the second virtual object.

13. The method according to claim 1, further comprising:
stopping displaying the threat object model and the threat warning control in response to that the second virtual object leaves the perception range of the first virtual object;
displaying the threat warning control in the virtual scene image in response to that the second virtual object enters the threat warning range again, and duration of leaving the threat warning range reaches a duration threshold; and
displaying the threat warning control and the threat object model in the virtual scene image in response to that the second virtual object enters the threat warning range again, and the duration of leaving the threat warning range does not reach the duration threshold.

14. The method according to claim 1, further comprising:
performing progressive transparency processing on the threat object model in response to that the second virtual object enters the visible range of the first virtual object.

15. An information display apparatus for a virtual object, comprising:
a processor and a memory, the memory having at least one piece of program code stored therein, the at least one piece of program code being loaded and executed by the processor to implement:
displaying a virtual scene image, the virtual scene image being an image of a virtual scene captured from a perspective of a first virtual object;
displaying a threat warning control in the virtual scene image after a second virtual object enters a threat warning range of the first virtual object, the threat warning control indicating a position of the second virtual object within the threat warning range, the second virtual object and the first virtual object belonging to different game camps, and the threat warning range being greater than a visible range of the first virtual object and less than a perception range of the first virtual object; and
displaying a threat object model in the virtual scene image in response to a trigger operation on the threat warning control, the threat object model representing attribute information of the second virtual object.

16. The apparatus according to claim 15, wherein the displaying a threat object model in the virtual scene image comprises:
generating the threat object model based on the attribute information of the second virtual object;
determining a target display position of the threat object model based on a position of the second virtual object in the virtual scene and a scene range represented by the virtual scene image; and
displaying the threat object model at the target display position of the virtual scene image.

17. The apparatus according to claim 16, wherein the generating the threat object model based on the attribute information of the second virtual object comprises:
determining status integrity of the second virtual object based on the attribute information of the second virtual object, the status integrity representing an integrity degree of a current status of the second virtual object;
determining a color fill proportion of the threat object model based on the status integrity, the color fill proportion being positively correlated to the status integrity; and
performing color filling on the threat object model based on the color fill proportion.

18. The apparatus according to claim 17, wherein the processor is further configured to implement:
determining a threat degree of the second virtual object to the first virtual object based on attribute information of the first virtual object and the attribute information of the second virtual object; and
the performing color filling on the threat object model based on the color fill proportion comprises:
performing color filling on the threat object model based on the color fill proportion by using a prompt color corresponding to the threat degree.

19. The apparatus according to claim 18, wherein the displaying a threat warning control in the virtual scene image comprises:
displaying, in the virtual scene image, the threat warning control in the prompt color corresponding to the threat degree.

20. A non-transitory computer-readable storage medium, the computer-readable storage medium having a computer program stored therein, the computer program being loaded and executed by a processor to implement:
displaying a virtual scene image, the virtual scene image being an image of a virtual scene captured from a perspective of a first virtual object;
displaying a threat warning control in the virtual scene image after a second virtual object enters a threat warning range of the first virtual object, the threat warning control indicating a position of the second virtual object within the threat warning range, the second virtual object and the first virtual object belonging to different game camps, and the threat warning range being greater than a visible range of the first virtual object and less than a perception range of the first virtual object; and
displaying a threat object model in the virtual scene image in response to a trigger operation on the threat warning control, the threat object model representing attribute information of the second virtual object.
